(19) United States
(12) Patent Application Publication
(10) Pub. No.: US 2024/0220405 A1
(43) Pub. Date: Jul. 4, 2024

(54) SYSTEMS AND METHODS FOR HOSTING AN INTERLEAVE ACROSS ASYMMETRICALLY POPULATED MEMORY CHANNELS ACROSS TWO OR MORE DIFFERENT MEMORY TYPES

(71) Applicant: Advanced Micro Devices, Inc., Santa Clara, CA (US)

(72) Inventors: Amit P. Apte, Austin, TX (US); Eric Christopher Morton, Austin, TX (US)

(73) Assignee: Advanced Micro Devices, Inc., Santa Clara, CA (US)

(21) Appl. No.: 18/091,329

(22) Filed: Dec. 29, 2022

(51) Int. Cl. G06F 12/02; G06F 13/16

(52) U.S. Cl. CPC G06F 12/0238; G06F 13/1647; G06F 13/1694; G06F 2212/7201

(57) ABSTRACT

The disclosed computing device can include at least one memory of a particular type having a plurality of memory channels, and at least one memory of at least one other type having a plurality of links. The computing device can also include remapping circuitry configured to homogenously interleave the plurality of memory channels with the at least one memory of the at least one other type. Various other methods, systems, and computer-readable media are also disclosed.

### BACKGROUND

Double data rate (DDR) memory is a common type of memory used for most modern processors. DDR memory (e.g., DDR synchronous dynamic random-access memory (SDRAM)) fetches data on both the leading edge and the falling edge of the clock signal that regulates it, thus the name “Double Data Rate.”

Compute express link (CXL) is an open standard for high-speed central processing unit (CPU)-to-device and CPU-to-memory connections, designed for high performance data center computers. Types of CXL devices include specialized and general-purpose accelerators, as well as memory expansion boards and storage-class memory (i.e., CXL Type 3 devices). These CXL memory expander devices provide a host central processing unit (CPU) with low-latency access to local memory and/or non-volatile storage.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for hosting an interleave across asymmetrically populated memory channels across two or more different memory types.

FIG. 2 is a block diagram of an additional example system for hosting an interleave across asymmetrically populated memory channels across two or more different memory types.

FIG. 3 is a flow diagram of an example method for hosting an interleave across asymmetrically populated memory channels across two or more different memory types.

FIG. 4 is a block diagram illustrating an example representation of a system hosting an interleave across asymmetrically populated memory channels across two or more different memory types.

FIG. 5 is a block diagram illustrating an example logical representation of a system hosting an interleave across asymmetrically populated memory channels across two or more different memory types.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for hosting an interleave across asymmetrically populated memory channels across two or more different memory types. An example computing device can include at least one memory of a particular type having a plurality of memory channels, and at least one memory of at least one other type having a plurality of links. The example computing device can also include remapping circuitry configured to homogenously interleave the plurality of memory channels with the at least one memory of the at least one other type. In some examples, the homogenous interleaving can be accomplished by treating a range of addresses as a number of logical destinations that is greater than or equal to a sum of a number of the plurality of memory channels and a number of the plurality of links. Additional examples can include redirecting one or more of the logical destinations to a number of physical destinations that is less than the number of logical destinations. In this way, a computing device having multiple types of memory hardware can be reprogrammed to satisfy various vendor requirements without requiring a change of hardware.

For purposes of illustration, the systems and methods disclosed herein employ an example system that performs the homogenous interleaving for twelve DDR channels and four CXL memory expander devices limited to 2×16 links. For a processor that does not have support for a fourteen channel interleave or for asymmetric memory sizes it can be undesirable to add this support using a complex hardware implementation due to the added expense of doing so. The disclosed systems and methods avoid a complex hardware solution by using a software implementation in which the moderator blocks that feed requests into the data fabric can treat a range of addresses as a sixteen channel interleave and the lookup through the address maps in the moderators can deploy a logical to physical re-mapping. In an example, twelve DDR memory channels are homogenously interleaved with four CXL memory devices having an identical capacity to the DDR memory, and these devices can be approximately rate matched to the DDR memory. The resulting hardware configuration can appear as a symmetric 16 channel interleave to the system. To limit CXL memory expander devices to 2×16 links, each ×16 link can be bifurcated into two ×8 links and four ×8 CXL memory expander devices can be connected to the 4×8 links. To the hardware, the system appears to have twelve DDR distributed home nodes and two CXL distributed home nodes each hosting twice the memory of each DDR home node.

In one example, a computing device includes at least one memory of a particular type having a plurality of memory channels, at least one memory of at least one other type having a plurality of links, and remapping circuitry configured to homogenously interleave the plurality of memory channels with the at least one memory of the at least one other type.

In another example, a computing device can be the computing device of the previously described example computing device, wherein the remapping circuitry is configured to treat a range of addresses as a number of logical destinations that is greater than or equal to a sum of a number of the plurality of memory channels and a number of the plurality of links and redirect one or more of the logical destinations to a number of physical destinations that is less than the number of logical destinations.

In another example, a computing device can be the computing device of any of the previously described example computing devices, wherein the remapping circuitry is configured to use one or more address maps to deploy a logical to physical re-mapping.

In another example, a computing device can be the computing device of any of the previously described example computing devices, wherein the at least one memory of the particular type includes a double data rate (DDR) memory and the at least one memory of the at least one other type includes a plurality of compute express link (CXL) memory expander devices individually having an identical storage capacity to the DDR memory.

In another example, a computing device can be the computing device of any of the previously described example computing devices, further including four CXL memory expander devices within the plurality of CXL memory expander devices and twelve DDR memory channels within the plurality of DDR memory channels.

In another example, a computing device can be the computing device of any of the previously described example computing devices, wherein the four CXL memory expander devices are limited to 2×16 links.

In another example, a computing device can be the computing device of any of the previously described example computing devices, wherein each of the 2×16 links is bifurcated into 2×8 links in a manner that yields 4×8 links connected to the four CXL memory expander devices.

In another example, a computing device can be the computing device of any of the previously described example computing devices, wherein moderator blocks of the computing device treat a range of addresses as a sixteen channel interleave and use one or more address maps to deploy a logical to physical re-mapping.

In another example, a computing device can be the computing device of any of the previously described example computing devices, wherein distributed home nodes that interface to the twelve DDR memory channels are configured to treat at least one of the one or more address maps as a sixteen way interleave.

In another example, a computing device can be the computing device of any of the previously described example computing devices, wherein distributed home nodes that interface to the four CXL memory expander devices are configured to treat the range of addresses as an eight way interleave.

In one example, a system can include at least one memory of a particular type having a plurality of memory channels, at least one memory of at least one other type having a plurality of links, at least one physical processor, and physical memory comprising computer-executable instructions that, when executed by the physical processor, cause the at least one physical processor to homogenously interleave the plurality of memory channels with the at least one memory of the at least one other type.

Another example can be the system of the previously described example system, wherein the instructions cause the at least one physical processor to treat a range of addresses as a number of logical destinations that is greater than or equal to a sum of a number of the plurality of memory channels and a number of the plurality of links and redirect one or more of the logical destinations to a number of physical destinations that is less than the number of logical destinations.

Another example can be the system of the previously described example system, wherein the remapping circuitry is configured to use one or more address maps to deploy a logical to physical re-mapping.

Another example can be the system of any of the previously described example systems, wherein the at least one memory of the particular type includes a double data rate (DDR) memory and the at least one memory of the at least one other type includes a plurality of compute express link (CXL) memory expander devices individually having an identical storage capacity to the DDR memory.

Another example can be the system of any of the previously described example systems, further including four CXL memory expander devices within the plurality of CXL memory expander devices and twelve DDR memory channels within the plurality of DDR memory channels.

Another example can be the system of any of the previously described example systems, wherein the four CXL memory expander devices are limited to 2×16 links.

Another example can be the system of any of the previously described example systems, wherein each of the 2×16 links is bifurcated into 2×8 links in a manner that yields 4×8 links connected to the four CXL memory expander devices.

Another example can be the system of any of the previously described example systems, wherein moderator blocks treat a range of addresses as a sixteen channel interleave and use one or more address maps to deploy a logical to physical re-mapping.

In one example, a computer-implemented method can include providing, by at least one processor, data communications with at least one memory of a particular type having a plurality of memory channels and at least one memory of at least one other type having a plurality of links, and homogenously interleaving, by the at least one processor, the plurality of memory channels with the at least one memory of the at least one other type.

Another example can be the method the previously described example method, wherein homogenously interleaving the plurality of memory channels with the at least one memory of the at least one other type includes treating, by the at least one processor, a range of addresses as a number of logical destinations that is greater than or equal to a sum of a number of the plurality of memory channels and a number of the plurality of links, and redirecting, by the at least one processor, one or more of the logical destinations to a number of physical destinations that is less than the number of logical destinations.

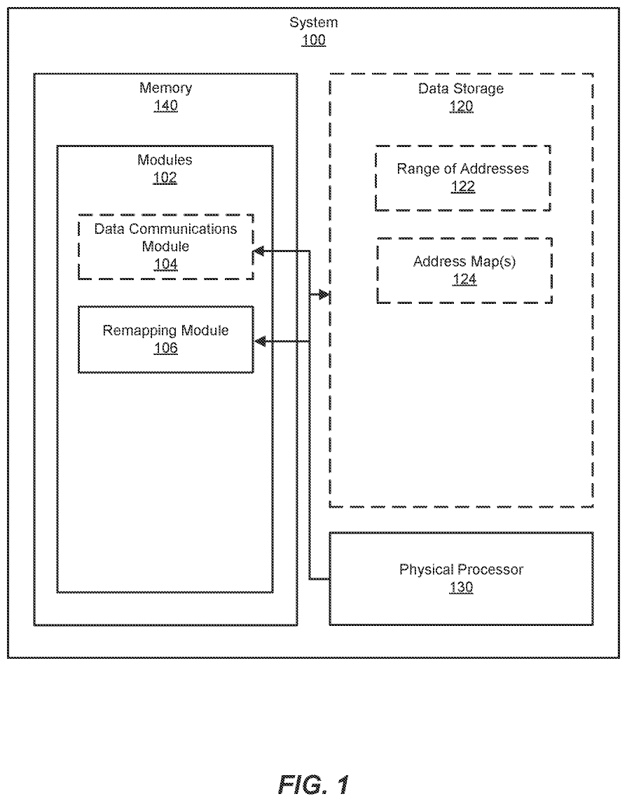

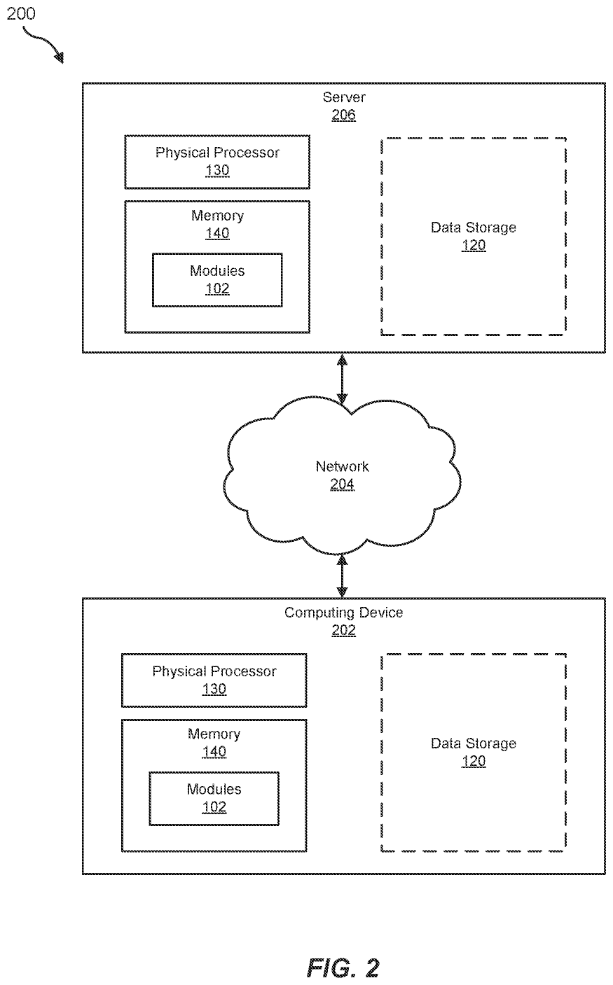

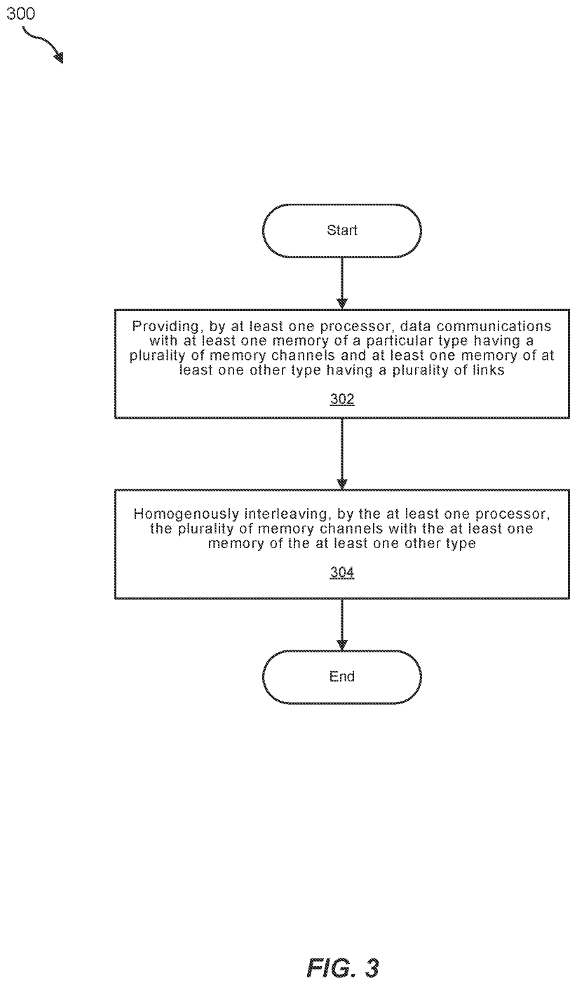

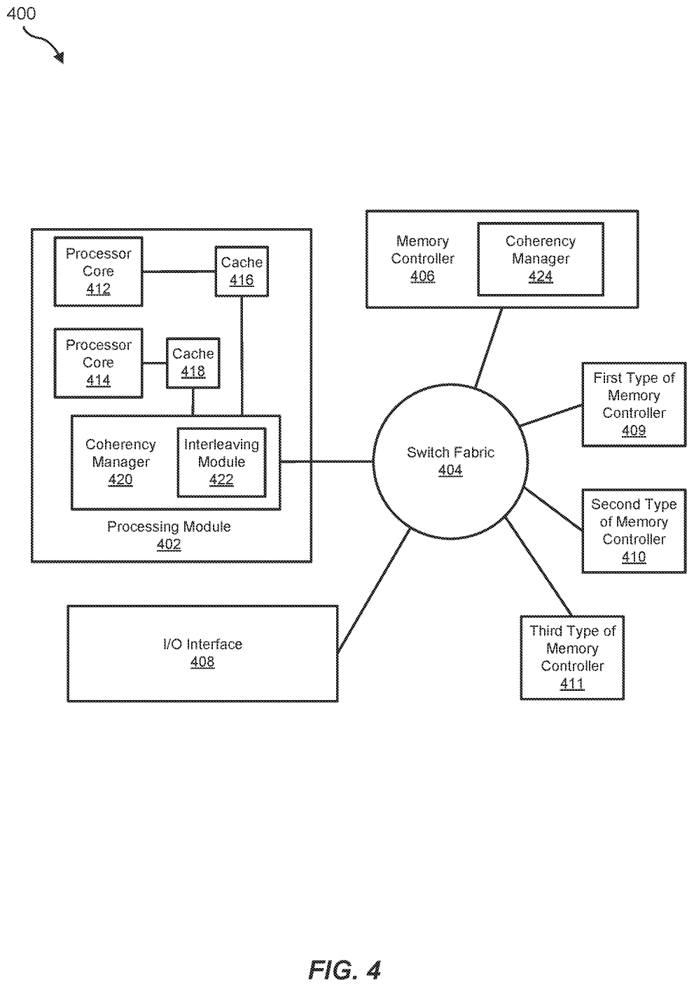

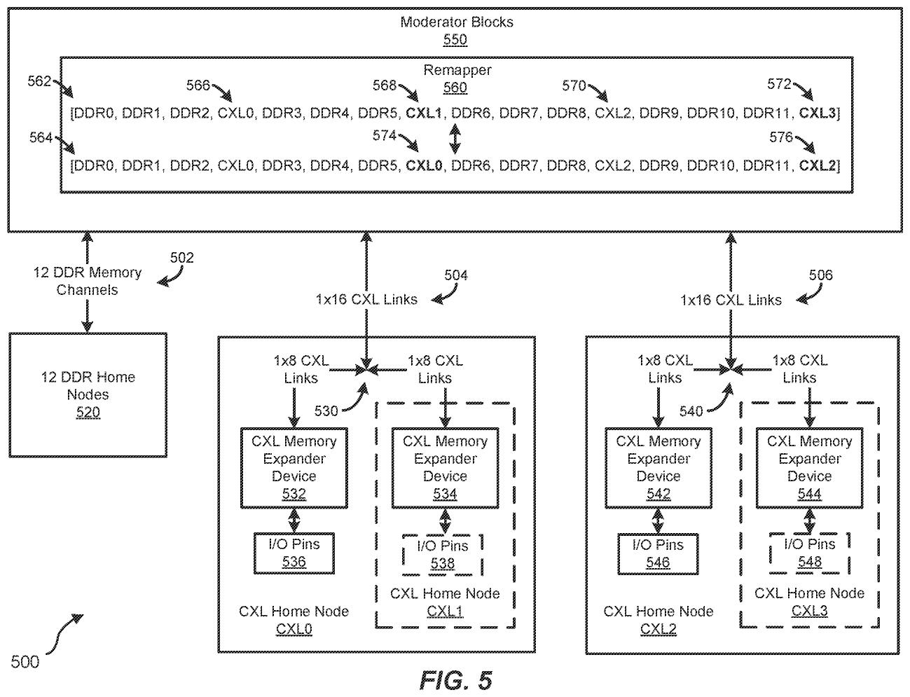

The following will provide, with reference to FIGS. 1-2, detailed descriptions of example systems for hosting an interleave across asymmetrically populated memory channels across two or more different memory types. Detailed descriptions of corresponding computer-implemented methods will also be provided in connection with FIG. 3. In addition, detailed descriptions of an example system hosting an interleave across asymmetrically populated memory channels across two or more different memory types will be provided in connection with FIGS. 4 and 5.

FIG. 1 is a block diagram of an example system 100 for hosting an interleave across asymmetrically populated memory channels across two or more different memory types. As illustrated in this figure, example system 100 can include one or more modules 102 for performing one or more tasks. As will be explained in greater detail below, modules 102 can include a data communications module 104 and a remapping module 106. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate hosting an interleave across asymmetrically populated memory channels across two or more different memory types. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data. In one example, data storage 120 includes databases, spreadsheets, tables, lists, matrices, trees, or any other type of data structure. Examples of data storage 120 include, without limitation, a range of addresses 122 and one or more address map(s) 124.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to host an interleave across asymmetrically populated memory channels across two or more different memory types.

Computing device 202 generally represents any type or form of computing device capable of reading computer-executable instructions. In some examples, computing device includes a processor interfaced with a plurality of DDR memory channels and a plurality of CXL memory expander devices. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some examples, server includes a processor interfaced with a plurality of DDR memory channels and a plurality of CXL memory expander devices. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for hosting an interleave across asymmetrically populated memory channels across two or more different memory types. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can provide data communications. For example, data communications module 104 can, as part of computing device 202 in FIG. 2, providing, by at least one processor, data communications with at least one memory of a particular type having a plurality of memory channels and at least one memory of at least one other type having a plurality of links.

As used herein, the term “data communications” generally refers to the electronic transmission of encoded information to, from, or between computers. Examples of data communications include, without limitation, simplex, duplex, and half duplex communications.

As used herein, the term “memory” generally refers to an electronic holding place for the instructions and/or data a computer needs to reach quickly. Examples of memory can include, without limitation, cache memory, main memory, and secondary memory. Different types of memory can be different in various aspects, such as numbers of channels or links, different storage capacities, different rates. For example, two or more different types of cache memory can be DDR memory and CXL memory expander devices.

As used herein, the term “channel” generally refers to a model for interprocess communication and synchronization via message passing. Examples of channels include, without limitation, buffered channels, synchronous channels, and asynchronous channels. The term “memory channel” can be used interchangeably herein with the terms “memory,” “DDR memory,” and/or “distributed home node.”

As used herein, the term “links” generally refers to any combination of hardware and/or software that provides a mechanism for data communications. Examples of links, without limitation, include point to point wired connections and/or communications pathways provided by a switch fabric and/or a communications network. The term “link” can be used interchangeably herein with the terms “CXL memory expander device,” and/or “distributed home node.”

Various examples of the systems described herein perform step 302 in a variety of ways. In one example, data communications module 104, as part of computing device 202 in FIG. 2, can limit four CXL memory expander devices to 2×16 links each bifurcated into 2×8 links in a manner that yields 4×8 links connected to the four CXL memory expander devices. Alternatively or additionally, data communications module 104, as part of computing device 202 in FIG. 2, can provide read and write access utilizing twelve DDR memory channels.

At step 304 one or more of the systems described herein can perform homogenous interleaving. For example, remapping module 106 can, as part of computing device 202 in FIG. 2, homogenously interleave, by the at least one processor, the plurality of memory channels with the at least one memory of the at least one other type.

As used herein, the term “interleave” generally refers to interspersing data. Examples of interleaving include, without limitation, interspersing of fields or channels of different meaning sequentially in memory, in processor registers, or in file formats. For an interleave to be “homogenous,” a range of addresses for the two or more different of memory can be mapped to logical destinations that are included in a same interleave. Thus, a number of logical destinations can be greater than or equal to a sum of the channels and the links. When the number of logical destinations is greater than the sum of the channels and the links, one or more of the logical destinations can be redirected to a number of physical destinations that is less than the number of logical destinations.

Various examples of the systems described herein perform step 304 in a variety of ways. In one example, remapping module 106, as part of computing device 202 in FIG. 2, can treat a range of addresses as a number of logical destinations that is greater than or equal to a sum of a number of the plurality of memory channels and a number of the plurality of links, and redirect one or more of the logical destinations to a number of physical destinations that is less than the number of logical destinations. In some examples, remapping module 106, as part of computing device 202 in FIG. 2, can, based on a chosen channel interleave in one or more moderators (e.g., a sixteen channel interleave), determine a “Logical” destination Home Node instance for an address, and re-direct the “Logical” destination to a “Physical” destination. In some implementations, remapping module 106, as part of computing device 202 in FIG. 2, can use one or more address maps with a first plurality of distributed home nodes (e.g., connected to twelve DDR memory channels) that is configured to treat at least one of the one or more address maps as a sixteen way interleave. In additional or alternative examples, remapping module 106, as part of computing device 202 in FIG. 2, can use the one or more address maps with a second plurality of distributed home nodes that is configured to treat the range of addresses as an eight way interleave. In some of these examples, second plurality of distributed home nodes are connected to four CXL memory expander devices limited to 2×16 links each bifurcated into 2×8 links in a manner that yields 4×8 links connected to the four CXL memory expander devices.

As used herein, the term “range of addresses” generally refers to a plurality of unique identifiers used by a device or CPU for data tracking. Examples of ranges of addresses include, without limitation, logical addresses and physical addresses. A physical address can be, for example, a memory address or the location of a memory cell in main memory. A logical address can be an address at which an item (e.g., memory cell, storage element, and/or network host) appears to reside from the perspective of an executing application program. A logical address can be different from the physical address due to the operation of an address translator or mapping function.

FIG. 4 shows an example system 400 hosting an interleave across asymmetrically populated memory channels across two or more different memory types. For example, system 400 can have a processing module 402, a memory controller 406, an input/output (I/O) interface 408, and memory controllers 409-411 of different types, all connected to a switch fabric 404. I/O interface 408 can be one or more mediums (e.g., I/O bus having data lines, address lines, and control lines) in which data are sent from internal logic to external sources and from which data are received from external sources. Switch fabric 404 can be a network topology in which network nodes interconnect via one or more network switches. Memory controllers 406-410 can be digital circuits that manage the flow of data going to and from a main memory. Memory controller 406 can be configured as part of a cache subsystem and have a coherency manager 424 that ensures the uniformity of shared resource data that ends up stored in multiple local caches. Memory controllers 409-411 can control the flow of data to and from memories of different types that can serve, for example, as local caches. Processing module 402 can be a physical processor that includes processor cores 412 and 414 connected to local caches 416 and 418 having their own coherency manager 420 that ensures the uniformity of shared resource data stored in local caches 416 and 418.

System 400 can perform interleaving in various ways. For example, coherency manager 420 can have an interleaving module 422 that converts a transmission channel with memory into one that is memoryless by permuting symbols according to a mapping. Additionally, interleaving module 422 can homogeneously interleave channels and/or links (e.g., can represent more than one set of channels for more than one memory device) of the different types of memory controllers 409-411. The homogenous interleave can treat a range of addresses as a number of logical destinations that is greater than or equal to a sum of a number of a plurality of memory channels for a first type of memory controller 409 and a number of a plurality of links for one or more other types of memory controllers (e.g., memory controllers 410 and/or 411).

System 400 can be configured and reconfigured in various ways by adapting one or more address maps employed by interleaving module 422 in a manner that reconfigures interleaving module 422 as remapping circuitry that uses the one or more address maps to deploy a logical to physical re-mapping. For example, the number of logical destinations can be greater than or equal to the sum of a number of the plurality of memory channels and the number of the plurality of links, and one or more of the logical destinations can be redirected to a number of physical destinations that is less than the number of logical destinations. Additionally, one or more of memory controllers 409-411 can implement their own interleaves in a manner that restricts and/or bifurcates links, with a home node being reconfigured to host multiple memory devices. In this way, home nodes and I/O interface components (e.g., pin connectors), can be reconfigured to meet various requirements without requiring a complex hardware solution.

FIG. 5 shows an example logical representation of a system 500 hosting an interleave across asymmetrically populated memory channels across two or more different memory types. This example performs remapping for twelve DDR memory channels 502 and four CXL memory expander devices 532, 534, 542, and 544 that normally have four ×8 links, but are restricted to two ×16 links 504 and 506. In this case, there are sixteen logical destinations corresponding to the twelve DDR memory channels 502 and the four ×8 links to the four CXL memory expander devices 532, 534, 542, and 544. However, there are fourteen physical destinations corresponding to the twelve DDR memory channels 502 and the two ×16 links 504 and 506 to which the four ×8 links are restricted.

As used herein, the term “CXL memory expander devices” generally refers to CXL Type 3 devices that provide a host CPU with low-latency access to local memory and/or non-volatile storage. Examples of CXL memory expander devices include, without limitation, memory expansion boards and storage-class memory.

In this example, system 500 can include one or more moderator blocks 540 that can have one or more remappers 550 that homogenously interleaves the memory channels 502 with the one or more memories of another type (e.g., CXL memory expander devices 532, 534, 542, and 544). To do so, the one or more remappers 550 can treat a range of addresses as a homogenous interleave 562 (e.g., sixteen channel interleave) having a number of logical destinations that is greater than or equal to a sum of the number (e.g., twelve) of memory channels 502 and the number (e.g., four) of ×8 links to CXL memory expander devices 532, 534, 542, and 544. Additionally, one or more remappers 550 can redirect one or more of the logical destinations of homogenous interleave 562 to a number (e.g., fourteen) of physical destinations 564 that is less than the number (e.g., sixteen) of logical destinations of homogenous interleave 562.

In this example, the logical destinations of homogenous interleave 562 can include logical destinations DDR0-DDR11 for twelve DDR home nodes 520 corresponding to twelve DDR memory channels 502. Additionally, the logical destinations of homogenous interleave 562 can include logical destinations 566-572 for four ×8 links corresponding to four CXL home nodes CXL0-CXL3. Remappers 550 can redirect logical destinations 568 and 572 (e.g., corresponding to CXL home nodes CXL1 and CXL3) to physical destinations 574 and 576 (e.g., corresponding to CXL home nodes CXL0 and CXL2). Accordingly, there can still be sixteen entries in physical destinations 564, but these entries are no longer unique. This remapping can allow CXL home node CXL0 to host both CXL memory expander devices 532 and 534 and allow CXL home node CXL2 to host both CXL memory expander devices 542 and 544. As a result, CXL memory expander devices 532 and 534 can both be accessed via I/O pin connector 536 for CXL home node CXL0 without the need to use I/O pin connector 538 for CXL home node CXL1. Likewise, CXL memory expander devices 542 and 544 can both be accessed via I/O pin connector 546 for CXL home node CXL2 without the need to use I/O pin connector 548 for CXL home node CXL3. This reconfigurability can meet the needs of various applications and devices without the need for a complex hardware solution.

Interleavers 530 and 540 of CXL home nodes CXL0 and CXL2 can restrict the four ×8 links to two ×16 links in one data communications path direction and bifurcate the two ×16 links into the four ×8 links on an opposite data communications path direction. Two ×8 links can be set up as an eight channel interleave, and an address from the eight channel interleave can then be normalized (e.g., by taking out three bits instead of four bits) before sending the associated traffic to the CXL memory controller. The CXL memory controller can then utilize an additional bit to interleave between the two ×8 memory devices. Such an implementation can limit the four CXL memory expander devices 532, 534, 542, and 544 to two ×16 links that are each bifurcated into 2×8 links in a manner that yields four ×8 links connected to the four CXL memory expander devices.

As set forth above, the systems and methods disclosed herein homogenously interleave twelve DDR memory channels and four CXL Type 3 (CXL.mem) devices with an identical capacity to the DDR memory, and these four CXL Type 3 (CXL.mem) devices can be approximately rate matched to the DDR memory. The home nodes that interface to the DDR memory can be treated differently than the home nodes that interface to CXL memory. The hardware can support a configuration where the four distributed CXL home nodes can be made to appear as a logical extension of the twelve distributed DDR home nodes and make this configuration look like a symmetric channel interleave to the system.

As used herein, the term “distributed home nodes” generally refers to devices that are controlled by one or more other devices (e.g., moderator blocks) and that are physically separate but linked together using a network (e.g., a switch fabric). Examples of distributed home nodes include, without limitation, DDR memory, DDR memory channels, CXL memory expander devices, and CXL memory channels.

Additionally, for a processor that has the ability to support 4×16 CXL Type 3 memory links with the CXL links sharing pins with logic that can be used to host either Socket to Socket xGMI links or Processor to I/O PCle links, it can be desirable for some applications to limit CXL Type 3 memory to two ×16 links. Each ×16 link can be bifurcated into two ×8 links and 4×8 CXL Type 3 devices can be connected to the 4×8 links thus created. To the hardware, this arrangement can look like a system with twelve DDR distributed home nodes and two CXL distributed home nodes, with each CXL home node hosting twice the size of memory of each DDR home node.

For a processor that does not have support for a fourteen channel interleave or for asymmetric memory sizes it can be undesirable to add this support using a complex hardware implementation. The disclosed systems and methods avoid a complex hardware solution by using a software implementation in which the moderator blocks that feed requests into the data fabric can treat a range of addresses as a sixteen channel interleave and the lookup through the address maps in the moderators can deploy a logical to physical re-mapping. For four CXL home nodes (e.g., numbered CXL0, CXL1, CXL2, and CXL3), requests intended for CXL1 instead can go to CMP0 and requests intended for CXL3 instead can go to CXL2. The distributed home nodes interfaced to the twelve DDR channels can perceive this address map as a sixteen way interleave. The distributed home nodes that interface to CXL memory (i.e., CXL0 and CXL2) can be programmed to treat the same range of addresses as an eight way interleave. In this way, the CXL memory can avoid objecting to receiving requests associated to their counterparts and can correctly normalize the physical addresses before passing them off to the CXL memory controller. This combination of a sixteen channel interleave and an eight channel interleave for the same range of addresses can achieve the objective of hosting an interleave across asymmetrically populated memory channels across two or more different memory types while avoiding the increased expense associated with resorting to a complex hardware implementation.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device comprising:
at least one memory of a particular type having a plurality of memory channels;
at least one memory of at least one other type having a plurality of links; and
remapping circuitry configured to homogenously interleave the plurality of memory channels with the at least one memory of the at least one other type.

2. The computing device of claim 1, wherein the remapping circuitry is configured to:
treat a range of addresses as a number of logical destinations that is greater than or equal to a sum of a number of the plurality of memory channels and a number of the plurality of links; and
redirect one or more of the logical destinations to a number of physical destinations that is less than the number of logical destinations.

3. The computing device of claim 2, wherein the remapping circuitry is configured to use one or more address maps to deploy a logical to physical re-mapping.

4. The computing device of claim 1, wherein the at least one memory of the particular type includes a double data rate (DDR) memory and the at least one memory of the at least one other type includes a plurality of compute express link (CXL) memory expander devices individually having an identical storage capacity to the DDR memory.

5. The computing device of claim 4, further comprising four CXL memory expander devices within the plurality of CXL memory expander devices and twelve DDR memory channels within the plurality of DDR memory channels.

6. The computing device of claim 5, wherein the four CXL memory expander devices are limited to 2×16 links.

7. The computing device of claim 6, wherein each of the 2×16 links is bifurcated into 2×8 links in a manner that yields 4×8 links connected to the four CXL memory expander devices.

8. The computing device of claim 7, wherein moderator blocks of the computing device treat a range of addresses as a sixteen channel interleave and use one or more address maps to deploy a logical to physical re-mapping.

9. The computing device of claim 8, wherein distributed home nodes that interface to the twelve DDR memory channels are configured to treat at least one of the one or more address maps as a sixteen way interleave.

10. The computing device of claim 9, wherein distributed home nodes that interface to the four CXL memory expander devices are configured to treat the range of addresses as an eight way interleave.

11. A system comprising:
at least one memory of a particular type having a plurality of memory channels;
at least one memory of at least one other type having a plurality of links;
at least one physical processor; and
physical memory comprising computer-executable instructions that, when executed by the physical processor, cause the at least one physical processor to homogenously interleave the plurality of memory channels with the at least one memory of the at least one other type.

12. The system of claim 11, wherein the instructions cause the at least one physical processor to:
treat a range of addresses as a number of logical destinations that is greater than or equal to a sum of a number of the plurality of memory channels and a number of the plurality of links; and
redirect one or more of the logical destinations to a number of physical destinations that is less than the number of logical destinations.

13. The system of claim 12, wherein the remapping circuitry is configured to use one or more address maps to deploy a logical to physical re-mapping.

14. The system of claim 11, wherein the at least one memory of the particular type includes a double data rate (DDR) memory and the at least one memory of the at least one other type includes a plurality of compute express link (CXL) memory expander devices individually having an identical storage capacity to the DDR memory.

15. The system of claim 14, further comprising four CXL memory expander devices within the plurality of CXL memory expander devices and twelve DDR memory channels within the plurality of DDR memory channels.

16. The system of claim 15, wherein the four CXL memory expander devices are limited to 2×16 links.

17. The system of claim 16, wherein each of the 2×16 links is bifurcated into 2×8 links in a manner that yields 4×8 links connected to the four CXL memory expander devices.

18. The system of claim 17, wherein moderator blocks treat a range of addresses as a sixteen channel interleave and use one or more address maps to deploy a logical to physical re-mapping.

19. A computer-implemented method comprising:
providing, by at least one processor, data communications with at least one memory of a particular type having a plurality of memory channels and at least one memory of at least one other type having a plurality of links; and
homogenously interleaving, by the at least one processor, the plurality of memory channels with the at least one memory of the at least one other type.

20. The method of claim 19, wherein homogenously interleaving the plurality of memory channels with the at least one memory of the at least one other type includes:
treating, by the at least one processor, a range of addresses as a number of logical destinations that is greater than or equal to a sum of a number of the plurality of memory channels and a number of the plurality of links; and
redirecting, by the at least one processor, one or more of the logical destinations to a number of physical destinations that is less than the number of logical destinations.
